(19) United States
(12) Patent Application Publication
(10) Pub. No.: US 2008/0243482 A1
(43) Pub. Date: Oct. 2, 2008

(54) Method for performing effective drill-down operations in text corpus visualization and exploration using language model approaches for key phrase weighting

(75) Inventors: Michal Skubacz, Grobenzell (DE); Cai-Nicolas Ziegler, Munich (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft, Munich (DE)

(21) Appl. No.: 11/797,632

(22) Filed: May 4, 2007

(30) Foreign Application Priority Data
Mar. 28, 2007 (EP) EP07006429

(51) Int. Cl. G06F 17/27

(52) U.S. Cl. 704/9

(57) ABSTRACT

The invention relates to a method and an apparatus for performing a drill-down operation on a text corpus comprising documents, using language models for key phrase weighting, said method comprising the steps of weighting key phrases occurring both in a foreground language model, which contains a selected document cluster of said text corpus, and in a background language model, which does not contain said selected document cluster, by calculating for each key phrase a key phrase weight comprising a ratio between the foreground weight of said key phrase and a background weight of said key phrase, and assigning documents of the foreground language model to cluster labels which are formed by key phrases having high calculated key phrase weights.

### BACKGROUND OF THE INVENTION

When searching for information and relevant documents, searching for meta data which describe documents and searching within data bases, it is often time-consuming to get the desired information. Documentation-heavy application areas, such as news summarization, service analysis and fault tracking, customer feedback analysis, medical diagnosis and process report analysis, trend scouting or technical and scientific literature search, require efficient means for exploration and filtering of the underlying textual information. Commonly, filtering of documents by topic segmentation is used to address the issue at hand. Conventional approaches for clustering documents take into account only a single text corpus, i.e. a so-called foreground language model. The foreground language model is formed by a text corpus which comprises a selected cluster of documents. The disadvantage of conventional methods for clustering text documents is that they do not differentiate efficiently the documents of the selected document cluster from other documents within other document clusters.

Accordingly, it is an object of the present invention to provide a method and an apparatus for performing a drill-down operation allowing a more specific exploration of documents, based on the use of language modelling.

### BRIEF SUMMARY OF THE INVENTION

The invention provides a method for performing a drill-down operation on a text corpus comprising documents using language models for key phrase weighting, said method comprising the steps of

weighting key phrases occurring both in a foreground language model which contains a selected document cluster of said text corpus and in a background language model which does not contain said selected document cluster by calculating for each key phrase a key phrase weight comprising a ratio between the foreground weight of said key phrase and a background weight of said key phrase; and

assigning documents of the foreground language model to cluster labels which are formed by key phrases having high calculated key phrase weights.

In an embodiment of the method according to the present invention, the foreground weight of said key phrase in the documents of the foreground language model which contains said selected document cluster and the background weight of said key phrase in the documents of the background language model which does not contain said selected document cluster are both calculated according to a predetermined weighting scheme.

In an embodiment of the method according to the present invention, the weighting scheme comprises a TF/IDF weighting scheme, an informativeness/phraseness measurement weighting scheme, a log-likelihood ratio test weighting scheme, a CHI Square-weighting scheme, a student's t-test weighting scheme or

a Kullback-Leibler distance weighting scheme.

In an embodiment of the method according to the present invention, the foreground weight of the key phrase is calculated by using a TF/IDF weighting scheme depending on a term frequency and an inverse document frequency of said key phrase in the documents of the foreground language model which contains said selected document cluster.

In an embodiment of the method according to the present invention, the background weight of the key phrase is calculated by using a TF/IDF weighting scheme depending on a term frequency and an inverse document frequency of said key phrase in the document of the background language model which does not contain said selected document cluster.

In an embodiment of the method according to the present invention, the key phrase weight w(k) is calculated by:

w(k)=└w_{fg}(k)/w_{bg}(k)┘·log └w_{fg}(k)+w_{bg}(k)┘,

wherein w_{fg} is a foreground weight of said key phrase (k) and,

wherein w_{bg} is the background weight of said key phrase (k).

In an embodiment of the method according to the present invention, the key phrase weight w(k) is calculated by:

w(k)=log └w_{fg}(k)/w_{bg}(k)┘·log └w_{fg}(k)+w_{bg}(k)┘,

wherein w_{fg} is the foreground weight of said key phrase (k) and,

wherein w_{bg} is the background weight of said key phrase (k).

In an embodiment of the method according to the present invention, the key phrase weight w(k) is calculated by:

$$w ( k ) = \frac{{w}_{fg} ( k )}{{w}_{bg} ( k )} ,$$

wherein w_{fg} is the foreground weight of said key phrase (k) and,

wherein w_{bg} is the background weight of said key phrase (k).

In an embodiment of the method according to the present invention, the key phrase weight w(k) is calculated by:

$$w ( k ) = log [ \frac{{w}_{fg} ( k )}{{w}_{bg} ( k )} ] ,$$

wherein w_{fg} is the foreground weight of said key phrase (k) and,

wherein w_{bg} is the background weight of said key phrase (k).

In an embodiment of the method according to the present invention, the text corpus is a monolingual text corpus or a multilingual text corpus.

In an embodiment of the method according to the present invention, said weighting scheme for calculation of a foreground weight and of said background weight of a key phrase (k) in a document weights also said key phrase depending on whether it is a meta tag, a key phrase within a title of said document, a key phrase within in an abstract of said document or a key phrase in a text of said document.

In an embodiment of the method according to the present invention, the document is a html-document.

In an embodiment of the method according to the present invention, the cluster labels of the document clusters are displayed for selection of the corresponding document clusters on a screen.

In an embodiment of the method according to the present invention, the selection of the corresponding document cluster is performed by a user.

In an embodiment of the method according to the present invention, the documents of the selected document cluster are displayed to the user on said screen.

The invention further provides a method for performing a drill-down operation on a text corpus comprising documents using language models for key phrase weighting comprising the steps of

clustering said text corpus into clusters each including a set of documents;

selecting a cluster from among the clusters to generate a foreground language model containing the selected document cluster and a background language model which does not contain the selected document cluster;

weighting key phrases occurring both in the foreground language model and in the background language model by calculating for each key phrase a key phrase weight comprising a ratio between a foreground weight of said key phrase and a background weight of said key phrase;

sorting the weighted key phrases according to the respective key phrase weight in descending order;

weighting a configurable number of key phrases having a high key phrase weight as cluster labels; and

assigning documents of a foreground language model to the selected cluster labels.

In an embodiment of the method according to the present invention, the selected cluster labels are displayed on a screen for selection of subclusters.

In an embodiment of the method according to the present invention, the selection of the subclusters is performed by a user.

The invention further provides a user terminal for performing a drill-down operation on a text corpus comprising documents stored in at least one data base using language models for key phrase weighting, said user terminal comprising

a screen for displaying cluster labels of selectable document clusters each including a set of documents;

a calculation unit for weighting key phrases occurring both in a foreground language model which contains a selected document cluster of said text corpus and in a background language model which does not contain said selected document cluster by calculating for each key phrase (k) a key phrase weight w(k) comprising a ratio between a foreground weight w_{fg}(k) of said key phrase (k) and a background weight w_{bg}(k) of said key phrase (k) and for assigning documents of said foreground language model to cluster labels which are formed by key phrases (k) having high calculated key phrase weights w(k).

In an embodiment of the user terminal according to the present invention, the user terminal is connected via a network to said data base.

In an embodiment of the user terminal according to the present invention, the network is a local network.

In an embodiment of the user terminal according to the present invention, the network is formed by the Internet. The invention further provides an apparatus for performing a drill-down operation on a text corpus comprising documents using language models for key phrase weighting, said apparatus comprising

means for weighting a key phrase (k) occurring both in a foreground language model which contains a selected document cluster of said text corpus and in a background language model which does not contain a selected document cluster by calculating for each key phrase (k) a key phrase weight w(k) comprising a ratio between a foreground weight w_{fg}(k) of said key phrase (k) and a background weight w_{bg}(k) of said key phrase (k); and

means for assigning documents of the foreground language model to cluster labels which are formed by key phrases (k) having high calculated key phrase weights w(k).

The invention further provides an apparatus for performing a drill-down operation on a text corpus comprising documents using language models for key phrase and weighting, wherein said apparatus comprises

means for clustering said text corpus into clusters each including a set of documents;

means for selecting a cluster from among the clusters to generate a foreground language model which contains the selected document cluster and a background language model which does not contain the selected document cluster;

means for weighting key phrases (k) occurring both in the foreground language model and in the background language model by calculating for each key phrase (k) a key phrase weight w(k) comprising a ratio between a foreground weight w_{fg}(k) of said key phrase and a background weight w_{bg}(k) of said key phrase (k);

means for sorting the weighted key phrases (k) according to their key phrase weights w(k);

means for selecting a configurable number of key phrases having the highest key phrase weight as cluster labels; and

means for assigning documents of the foreground-language model to the selected cluster labels.

In the following, possible embodiments of the method and apparatus according to the present invention are described with reference to the enclosed figures.

### BRIEF DESCRIPTION OF THE FIGURES

FIG. 1 shows a diagram for illustrating an exemplary document base for performing a method according to the present invention;

FIG. 2 shows a flowchart for illustrating the drill-down operation according to an embodiment of the method according to the present invention;

FIG. 3 shows a flowchart of a possible embodiment of a method according to the present invention;

FIGS. 4A, 4B show diagrams for illustrating different possible embodiments of the method according to the present invention;

FIG. 5 shows a block diagram for illustrating a possible embodiment of a system for performing the method according to the present invention;

FIGS. 6A, 6B show diagrams for illustrating a practical example for performing a method according to the present invention.

### DETAILED DESCRIPTION OF THE FIGURES

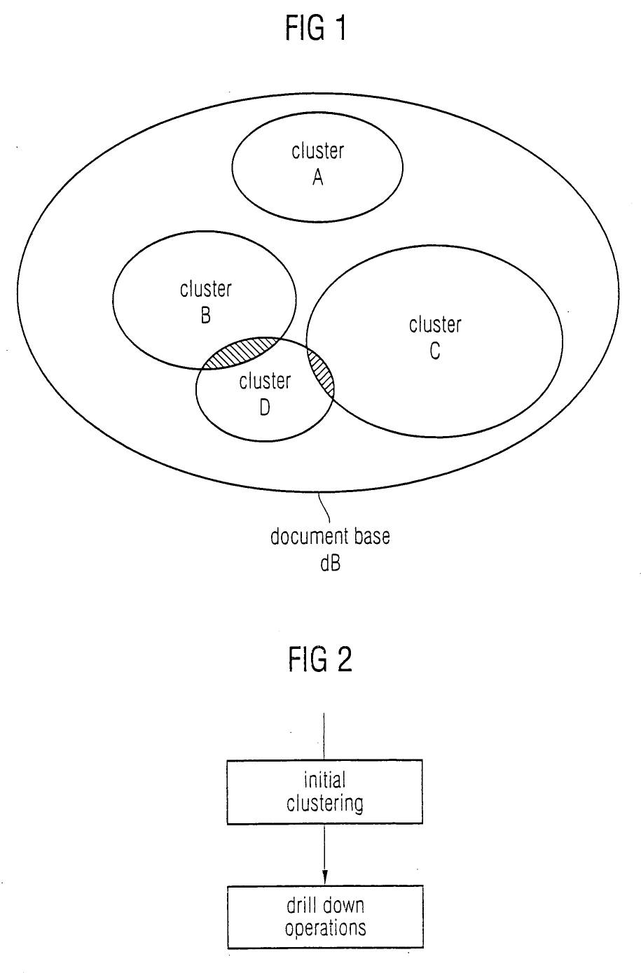

FIG. 1 is a diagram showing a document base dB consisting of a plurality of documents d, such as text documents. This document base dB forms a text corpus comprising a plurality of documents d. The text corpus is formed by a large set of documents including text documents which are electronically stored and processable. The text corpus can contain text documents in a single language or text documents in multiple languages. Accordingly, the text corpus on which a drill-down operation according to the present invention is performed can be a mono-lingual text corpus or a multi-lingual text corpus. The documents d forming the document base dB shown in FIG. 1 can be any kind of documents, such as text documents, multimedia documents comprising text or, for example, an HTML-document. Each cluster shown in FIG. 1 is a subset of documents within the document base dB. The document base dB may be formed, for instance, by a set of feedback messages which users have submitted in response to an online survey of user satisfaction. The document base dB can be segmented into so-called document clusters. A document cluster comprises a subset of documents, wherein the cluster is represented through a cluster label. A cluster label is formed, for example, by textual labels, i.e. a list of key words or key phrases (k). As can be seen from FIG. 1, the document clusters are not necessarily disjoint, i.e. a document d may be part of more than one cluster. Accordingly, the clusters can overlap as shown in FIG. 1. As can be seen from FIG. 1, cluster D overlaps with clusters B, C, i.e. there are documents which form part of cluster C as well as of cluster D and there are also documents which form part of the cluster B as well as of cluster D. Document clusters can be visualized in an appropriate way, for example, by using a treemap visualization scheme displayed on a screen to a user. The clusters are visualized so that they are selectable by a user, that is, boundaries between clusters are defined and are clearly visible to the user.

FIG. 2 shows a simple flowchart illustrating two subsequent sets for performing a clustering of text documents, i.e. an initial segmentation step or an initial clustering step to separate documents into different clusters and subsequent drill-down operation steps.

The initial document base dB comprises a plurality of text documents, wherein each text document has text words or key phrases. The terms or phrases of the text document can be sorted into an index vector including all words occurring in said document into a corresponding term vector indicating how often the respective word occurs in the respective text document. Usually, some words are not very significant because they occur very often in the document and/or have no significant meaning, such as articles (“a”, “the”). Therefore, a stop words removal is performed to get an index vector with a reduced set of significant phrases. The key phrases k are weighted using weighting schemes, such as TF/IDF weighting and are then sorted in descending order, wherein the key phrases with the highest calculated weights w(k) are placed on top of a selection list. A predetermined number (N) of sorted key phrases k are, for example ten key words or key phrases k and are then selected as cluster labels L for respective document clusters DC. Finally, the documents d of the data base dB are assigned to document clusters DC labelled by the selective key phrases k having the highest key phrase weights w(k). The clustering of documents d always comprises a labelling and an assignment step, wherein labelling of the document cluster can be performed before or after the assignment of the documents d to a document cluster DC.

After this initial clustering step, the found cluster labels L are displayed to a user on a screen.. If the user is interested in a specific document cluster and its data content and likes to examine and to explore text documents contained in the respective document cluster, the user clicks on the cluster of interest and a further segmentation is triggered. This segmentation step is called a drill-down operation. Upon triggering, the drill-down operates only documents associated with the cluster at hand denoted C which is selected for further segmentation. The referenced set of documents is denoted D_{C}, wherein D_{C} is a strict subset of the document set D of the data base dB.

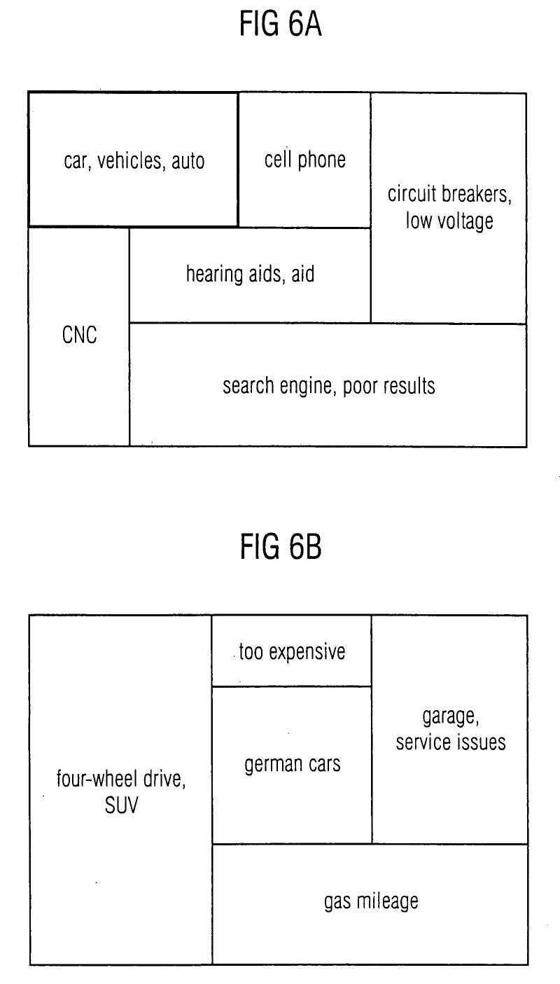

FIGS. 6A, 6B show an example for visualization of different clusters. The initial clustering is depicted in FIG. 6A. When the user clicks on the cluster with the cluster label “car, vehicles, auto”, all documents that are associated with this cluster (and only these documents) are segmented forming new clusters. To this end, relevance and salience of key terms/phrases k is determined. As can be seen from FIG. 6A, each rectangle represents a cluster and is identified by the cluster labels L given therein. Cluster labels L which are assigned consist of so-called key terms, such as “car”, “CNC”, “aid” or so-called key phrases k which consist of more than one term, such as “hearing aids”, “circuit breakers”. To each cluster, as shown in FIG. 6A, a certain number of documents d is associated. The key phrases or key terms can be associated to more than one cluster depending on the used clustering technique.

After a drill-down operation, when the user has selected the cluster “car, vehicles, auto”, subclusters are displayed as shown in FIG. 6B. The text documents d of the initial cluster are segmented anew to the cluster structure as shown in FIG. 6B. Hence, the initial document set of the cluster “car, vehicles, auto” is reduced in an ad-hoc fashion allowing a successive document set exploration by the user.

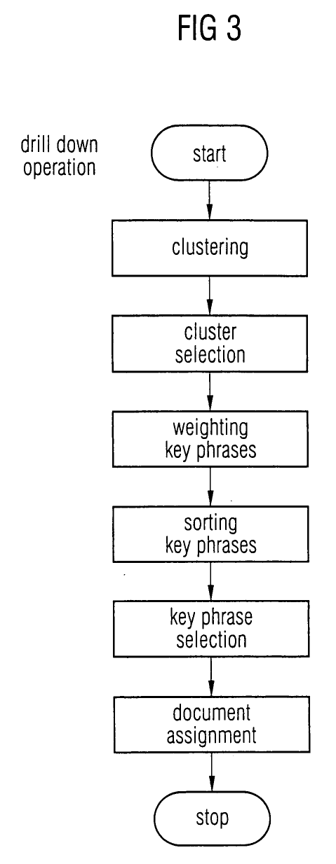

FIG. 3 shows a flowchart of a possible embodiment of the method for performing a drill-down operation in a text corpus according to the present invention. After clustering the text corpus into clusters which include a set of documents d, a document cluster DC from among the document clusters is selected to generate a foreground language model and a background language model. The foreground language model contains all documents of the selected document clusters DC, whereas the background language model does not contain the documents d of the selected document cluster DC. On the basis of all documents of the selected document cluster, referred to as the foreground language model, an index vector for all words within the selected cluster is generated and a stop word removal can be performed. The remaining significant words or key phrases k are then weighted in a further step of a drill-down operation as can be seen in FIG. 3. After selection of a cluster, there are two document sets, i.e. document set D_{C} forming a subset of a superset D of documents d of the document base dB. To cluster all documents d in the document set D_{C} it is desirable to separate the documents d as clearly as possible from the remaining documents of superset D. Accordingly, the clusters are selected according to the current context. To achieve this, the method according to the present invention computes two different weights for each key phrase or key term k of document set D_{C} of the selected document cluster. As a first weight which is referred to as foreground weight denoted by w_{fg}(k), a score is computed by calculating a relevance of the key phrase k for the currently selected document set D_{C}:

w_{fg}(k)=w(k, D_{C})

As a second weight which is referred to as background weight and denoted by w_{bg}(k) of the key phrase k, a score is calculated for the superset of documents, i.e. document set D. Accordingly, the background weight is given by:

w_{bg}(k)=w(k, D).

Any weighting scheme w can be used, for example a TF/IDF weighting scheme, an informativeness/phraseness measurement weighting scheme, a binomial log-likelihood ratio test (BLRT) weighting scheme, a CHI Square weighting scheme, student's-t-test weighting scheme or Kullback-Leibler divergence weighting scheme.

After calculating the foreground weight w_{fg} and the background weight w_{bg}, the ratio between the foreground weight w_{fg} and the background w_{bg} is calculated indicating how specific the respective key phrase k is for the currently selected foreground model. To get cluster labels L which are typical for the context, i.e. a selected cluster, and which at the same time are atypical for a general background model or surrounding contexts, a ratio between the foreground weight w_{fg} and the background weight w_{bg} has to be maximized.

In a possible embodiment of the method according to the present invention, the key phrase weight w(k) is calculated by:

w(k)=└w_{fg}(k)/w_{bg}(k)┘·log └w_{fg}(k)+w_{bg}(k)┘

Accordingly, the weight w for the key phrase k is determined by calculating the ratio between the foreground and the background weight and by multiplying this ratio with the logarithm of the sum of both weights. The larger the ratio is the higher is the final key phrase weight of the key phrase. The rationale behind taking the sum of the foreground and the background weight is to encourage key phrases k that have a high foreground weight and a high background weight as opposed to key phrases k that have both a low foreground and low background weight. When only taking the ratio between the foreground weight w_{fg} and the background weight w_{bg}, it can happen that a key phrase k occurs that has a low foreground weight w_{fg} but an even lower background weight w_{fg} (so that the ratio between both weights is again high) giving a large overall key phrase weight w. This is avoided by multiplying the ratio with the logarithm of the sum of both weights w_{fg} and w_{bg}. The logarithm as employed in the calculation of the key phrase weight has also a dampening effect.

The above given formula is only a possible embodiment.

With the method according to the present invention, the rating is performed by computing two key phrase weights, i.e. the background w_{bg} and the foreground weight w_{fg} by combining both weights into one score based upon a ratio of both weights.

In a possible embodiment, the key phrase weight w(k) is calculated by:

w(k)=log └w_{fg}(k)/w_{bg}(k)┘·log w_{fg}(k)+w_{bg}(k)┘.

In a further embodiment of the method according to the present invention, the key phrase weight w(k) is calculated by:

$$w ( k ) = \frac{{w}_{fg} ( k )}{{w}_{bg} ( k )}$$

In another embodiment of the method according to the present invention, the key phrase weight w(k) is calculated by:

$$w ( k ) = log [ \frac{{w}_{fg} ( k )}{{w}_{bg} ( k )} ]$$

As can be seen from the above formulas, the key phrase weight w(k) comprises in all embodiments a ratio between the foreground weight w_{fg}(k) of the key phrase k and the background weight w_{bg}(k) of the same key phrase k.

When using, for instance a TF/IDF weighting scheme the foreground weight w_{fg} of the key phrase k is calculated depending on the term frequency TF and the inverse document frequency IDF of the key phrase k in the respective documents of the foreground language model which contains the selected document cluster.

In the same manner, the background weight w_{bs} of the key phrase k is calculated when using the TF/IDF weighting scheme depending on the term frequency TF and depending on the inverse document frequency IDF of the key phrase k in the documents of the background language model which does not contain the selected document cluster.

The TF/IDF weighting scheme is used for information retrieval and text mining. This weighting scheme is a statistical measure to evaluate how important a phrase or term is to a document collection or a text corpus. The importance of a key phrase increases proportionally to the number of times the key phrase appears in a document but is offset by the frequency of the key phrase in the text corpus. The term frequency TF is the number of times a given key phrase or term appears in a document. The inverse document frequency IDF is a measure of the general importance of a key phrase k. The inverse document frequency IDF is the logarithm of the number of all documents divided by a number of documents containing the respective key phrase k or term.

After the calculation of the key phrase weights Iₖ of the key phrases k, the key phrases k are sorted in a further step as shown in FIG. 3 according to their key phrase weights wₖ, for example in a descending order.

Then, in a further step, the configurable number N of key phrases k having the highest key phrase weights wₖ are selected as cluster labels L.

In a further step, the documents of the foreground language model are assigned to the selected cluster labels L as can be seen in FIG. 3.

In a possible embodiment, the selected cluster labels L are displayed for the user on a screen, so that the user can select subclusters using the displayed cluster labels L.

In a possible embodiment, the selected cluster labels L are displayed on a touch screen of a user terminal. A user touches the screen at the displayed cluster label of the desired subcluster to perform the selection of the respective document cluster.

A further drilling step to the selected cluster can be performed in the same manner as shown in FIG. 3.

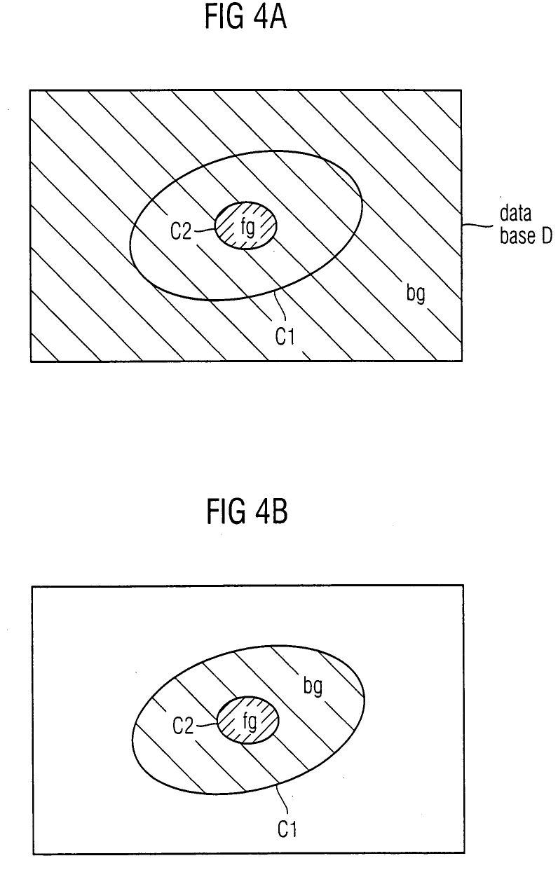

FIG. 4A is a diagram for illustrating a first possible embodiment of the method according to the present invention.

After a first drill-down operation, the data base dB is narrowed down to cluster C1. After a further drill-down operation, the set of documents is narrowed down to document cluster C2.

The foreground language model is formed by the document cluster C2.

In the embodiment as shown in FIG. 4A, the background language model is formed by all remaining documents d, e.g. the entire document set D of the data base dB.

In another embodiment as shown in FIG. 4B, the background language model is formed only by the documents d of document cluster C1 as found during the proceeding drill-down operation.

The method according to the present invention for performing a drill-down operation allows in principle an infinite deep drill-down into a document data base dB. From the user's perspective, drill-down operations are performed until the set of documents of the current context, i.e. the foreground model, is sufficiently small. In this case, the user has a look on the actual documents of the current context and does not perform a further drill-down operation.

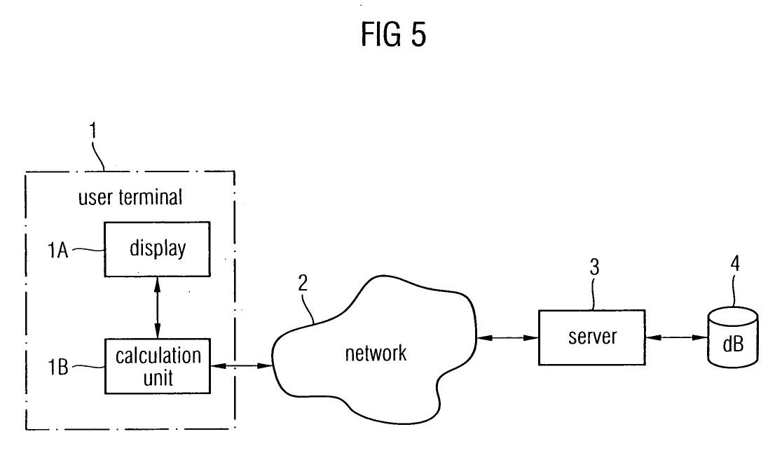

FIG. 5 shows an exemplary data communication system having a user terminal 1 according to an embodiment of the present invention. The user terminal 1 is connected via a network 2 to a server 3 having a data base 4. The network 2 can be any data network, such as an LAN-network or the Internet. The user terminal 1 in the shown embodiment comprises a screen 1A for displaying cluster labels L of selectable document clusters DC each including a set of documents d. Furthermore, the user terminal 1 according to the embodiment as shown in FIG. 5 comprises a calculating unit 1B for weighting key 200701364 phrases k occurring both in a foreground language model which contains a selected document cluster DC of the text corpus and in a background language model which does not contain the selected document cluster DC. The calculation unit 1B performs a weighting of key phrases by calculating for each key phrase k a key phrase weight w(k) comprising a ratio between the foreground weight w_{fg}(k) of said key phrase k and a background weight w_{bg}(k) of key phrase k. The calculating unit 1B then assigns documents d of the foreground language model to cluster labels L which are formed by key phrases k having the highest calculated key phrase weights w(k). The calculation unit 1B is, for example, performed by a microprocessor.

With the method and apparatus for performing a drill-down operation according to the present invention, the intra-cluster similarity for each document cluster DC is maximized whereas the inter-cluster similarity across different document clusters is minimized. The method according to the present invention can be used for clustering text documents according to their content, extracting key phrases and supporting hierarchical drill-down operations for refining a currently focused document set in an effective way by using language models for weighting cluster labels L.

The method according to the present invention can be applied to text corpora containing a very large number of documents as well as to text corpora containing a small number of documents, e.g. sentences or short comments.

A user drills, for example into the cluster “car, vehicles, auto” as shown in FIG. 6A, when the user wants to explore all documents d that have something to do with cars and vehicles, i.e. document set D_{C}. If, for example, a key phrase k, such as “Siemens”, frequently occurs in a document subset D_{C}, the weight w(k) of the key phrase “Siemens” will be high. However, the key phrase “Siemens” does not only occur frequently in the current context D_{C} but also in the entire document set D. Therefore, the key phrase “Siemens” is not typical for the cluster at hand which might be falsely assumed using a conventional method.

With the method according to the present invention by computing a weight ratio between a foreground and a background model, the key phrase weight w(k) of the key phrase k (for example, “Siemens”) is not very high since the ratio between the foreground and the background weight is low.

When using another key phrase k, such as the term “steering wheel”, the weight with respect to the context D_{C} is not as high as the weight of the key phrase “Siemens”. However, the key phrase “steering wheel” is typical for cars and therefore its occurrence in documents d other than those of the current context D_{C}, i.e. documents d contained in the document set D but not in the context D_{C}, is rather low. Consequently, the background weight w_{bg} of the key phrase “steering wheel” is low and the foreground weight w_{fg} of the key phrase “steering wheel” is high, resulting in an overall key phrase weight w(k) of the key phrase “steering wheel” which is much higher than the key phrase weight w(k) of the key phrase “Siemens”. Accordingly, with the method according to the present invention the key phrase “steering wheel” is more likely to become a subcluster of the current context D_{C} than the key phrase “Siemens”. Accordingly, the method according to the present invention reflects what a user desires when drilling into a set D of documents d.

1. A method for performing a drill-down operation on a text corpus comprising documents using language models for key phrase weighting, said method comprising the steps of:
(a) weighting key phrases occurring both in a foreground language model, which contains a selected document cluster of said text corpus, and in a background language model, which does not contain said selected document cluster, by calculating for each key phrase a key phrase weight comprising a ratio between the foreground weight of said key phrase and a background weight of said key phrase; and
(b) assigning documents of the foreground language model to cluster labels which are formed by key phrases having high calculated key phrase weights.

2. The method according to claim 1,
wherein the foreground weight of said key phrase in the documents of the foreground language model, which contains said selected document cluster, and the background weight of said key phrase in the documents of the background language model, which does not contain said selected document cluster, are both calculated according to a predetermined weighting scheme.

3. The method according to claim 2,
wherein the weighting scheme comprises
a TF/IDF weighting scheme,
an informativeness/phraseness measurement weighting scheme,
a binomial log-likelihood ratio test weighting scheme (BLRT),
a CHI Square-weighting scheme,
a student's t-test weighting scheme or
a Kullback-Leibler divergence weighting scheme.

4. The method according to claim 3,
wherein the foreground weight of the key phrase is calculated by using a TF/IDF weighting scheme depending on a term frequency (TF) and an inverse document frequency (IDF) of said key phrase in the documents of the foreground language model which contains said selected document cluster.

5. The method according to claim 3,
wherein the background weight of the key phrase is calculated by using a TF/IDF weighting scheme depending on a term frequency (TF) and an inverse document frequency (IDF) of said key phrase in the document of the background language model which does not contain said selected document cluster.

6. The method according to claim 1,
wherein the key phrase weight w(k) is calculated by:
w(k)=└w_{fg}(k)/w_{bg}(k)┘·log └w_{fg}(k)+w_{bg}(k)┘,
wherein w_{fg} is a foreground weight of said key phrase (k) and,
wherein w_{bg} is the background weight of said key phrase (k).

7. The method according to claim 1,
wherein the key phrase weight w(k) is calculated by:
w(k)=log └w_{fg}(k)/w_{bg}(k)┘·log └w_{fg}(k)+w_{bg}(k)┘,
wherein w_{fg} is the foreground weight of said key phrase (k) and,
wherein w_{bg} is the background weight of said key phrase (k).

8. The method according to claim 1,
wherein the key phrase weight w(k) is calculated by:
$$w ( k ) = \frac{{w}_{fg} ( k )}{{w}_{bg} ( k )} ,$$
wherein w_{fg} is the foreground weight of said key phrase (k) and,
wherein w_{bg} is the background weight of said key phrase (k).

9. The method according to claim 1,
wherein the key phrase weight w(k) is calculated by:
$$w ( k ) = log [ \frac{{w}_{fg} ( k )}{{w}_{bg} ( k )} ] ,$$
wherein w_{fg} is the foreground weight of said key phrase (k) and,
wherein w_{bg} is the background weight of said key phrase (k).

10. The method according to claim 1,
wherein the text corpus is a monolingual text corpus or a multilingual text corpus.

11. The method according to claim 2,
wherein said weighting scheme for calculation of said foreground weight and of said background weight of a key phrase in a document weights also said key phrase depending on whether it is a meta tag, a key phrase within a title of said document, a key phrase within an abstract of said document or a key phrase in a text of said document.

12. The method according to claim 1,
wherein the document is an HTML-document.

13. The method according to claim 1,
wherein the cluster labels of the document clusters are displayed for selection of the corresponding document clusters on a screen.

14. The method according to claim 13,
wherein the selection of the corresponding document cluster is performed by a user.

15. The method according to claim 13,
wherein the documents of the selected document cluster are displayed to the user on said screen.

16. A method for performing a drill-down operation on a text corpus comprising documents using language models for key phrase weighting comprising the steps of:
(a) clustering said text corpus into clusters each including a set of documents;
(b) selecting a cluster from among the clusters to generate a foreground language model containing the selected document cluster and a background language model which does not contain the selected document cluster;
(c) weighting key phrases occurring both in the foreground language model and in the background language model by calculating for each key phrase a key phrase weight comprising a ratio between a foreground weight of said key phrase and -a background weight of said key phrase;
(d) sorting the weighted key phrases according to the respective key phrase weight in descending order;
(e) weighting a configurable number of key phrases having a high key phrase weight as cluster label; and
(f) assigning documents of a foreground language model to the selected cluster labels.

17. The method according to claim 16,
wherein the selected cluster labels are displayed on a screen for selection of subclusters.

18. The method according to claim 17,
wherein the selection of the subclusters is performed by a user.

19. A user terminal for performing a drill-down operation on a text corpus comprising documents stored in at least one data base using language models for key phrase weighting, said user terminal comprising:
(a) a screen for displaying cluster labels of selectable document clusters each including a set of documents;
(b) a calculation unit for weighting key phrases occurring both in a foreground language model, which contains a selected document cluster of said text corpus, and in a background language model, which does not contain said selected document cluster, by calculating for each key phrase a key phrase weight comprising a ratio between a foreground weight of said key phrase and a background weight of said key phrase and for assigning documents of said foreground language model to cluster labels which are formed by key phrases having high calculated key phrase weights.

20. The user terminal according to claim 19,
wherein the user terminal is connected via a network to said data base.

21. The user terminal according to claim 20,
wherein the network is a local network.

22. The user terminal according to claim 20,
wherein the network is formed by the Internet.

23. An apparatus for performing a drill-down operation on a text corpus comprising documents using language models for key phrase weighting, said apparatus comprising:
(a) means for weighting a key phrase occurring both in a foreground language model, which contains a selected document cluster of said text corpus, and in a background language model, which does not contain a selected document cluster, by calculating for each key phrase a key phrase weight comprising a ratio between a foreground weight of said key phrase and a background weight of said key phrase; and
(b) means for assigning documents of the foreground language model to cluster labels which are formed by key phrases having high calculated key phrase weights.

24. An apparatus for performing a drill-down operation on a text corpus comprising documents using language models for key phrase weighting,
wherein said apparatus comprises:
(a) means for clustering said text corpus into clusters each including a set of documents;
(b) means for selecting a cluster from among the clusters to generate a foreground language model which contains the selected document cluster and a background language model which does not contain the selected document cluster;
(c) means for weighting key phrases occurring both in the foreground language model and in the background language model by calculating for each key phrase a key phrase weight comprising a ratio between a foreground weight of said key phrase and a background weight of said key phrase;
(d) means for sorting the weighted key phrases according to the key phrase weight;
(e) means for selecting a configurable number of key phrases having the highest key phrase weight as cluster labels; and
(f) means for assigning documents of the foreground language model to the selected cluster labels.
